(19) United States
(12) Patent Application Publication
(10) Pub. No.: US 2013/0136048 A1
(43) Pub. Date: May 30, 2013

(54) METHOD AND DEVICE FOR TRANSMITTING AND RECEIVING DOWNLINK DATA FOR NO-MOBILITY MOBILE STATION IN IDLE STATE

(71) Applicants: Heejeong Cho, Anyang-si (KR); Eunjong Lee, Anyang-si (KR); Youngsoo Yuk, Anyang-si (KR)

(72) Inventors: Heejeong Cho, Anyang-si (KR); Eunjong Lee, Anyang-si (KR); Youngsoo Yuk, Anyang-si (KR)

(73) Assignee: LG ELECTRONICS INC., Seoul (KR)

(21) Appl. No.: 13/811,631

(22) PCT Filed: Jul. 22, 2011
(86) PCT No.: PCT/KR2011/005439

§ 371 Date: Jan. 22, 2013

Related U.S. Application Data
(60) Provisional application No. 61/366,533, filed on Jul. 22, 2010.
(60) Provisional application No. 61/367,461, filed on Jul. 26, 2010.

(30) Foreign Application Priority Data
Jul. 22, 2011 (KR) 10-2011-0072948

(51) Int. Cl. H04W 72/04

(52) U.S. Cl. CPC H04W 72/042
USPC 370/311

(57) ABSTRACT

Disclosed are a method and a device for transmitting and receiving downlink data for a no-mobility mobile station in an idle state. A terminal device for receiving downlink data for a no-mobility mobile station in an idle state of the present invention comprises a receiver for receiving from a base station a first information including information on whether a downlink area has been allocated for a no-mobility mobile station in an idle state just for a terminal in an idle state without mobility. The receiver is configured to additionally receive a second information including information on the allocated downlink area, and the first information can be one of the following a super-frame header (SFH), a broadcast control channel (BCCH), a non-user specific A-MAP, an extended non-user specific A-MAP, and a physical downlink control channel (PDCCH).

### FIELD OF THE INVENTION

The present invention relates to wireless communication, and more particularly to a method and apparatus for transmitting and receiving downlink data for an idle-state mobile station (MS) having no mobility.

### BACKGROUND ART

A broadband wireless communication system is based on an orthogonal frequency division multiplexing (OFDM) scheme and an orthogonal frequency division multiple access (OFDMA) scheme, and transmits a physical channel signal using a plurality of subcarriers so as to implement high-speed data transmission.

Downlink data types transmitted from a base station (BS) to a mobile station (MS) can be largely classified into a multicasting/broadcasting data type and a unicast type. The multicasting/broadcasting data type can be used for the BS to transmit system information, configuration information, software upgrade information, etc. to one or more groups including unspecific/specific MSs. The unicast data type may be used for the BS to transmit requested information to a specific MS, or may also be used to transmit a message including information (for example, configuration information) to be transferred only to a specific MS.

Meanwhile, uplink data types transmitted from an MS to a BS or another MS may include a unicast data type. The MS can finally transmit a message including specific information to be transferred to another MS or a server to the BS.

Although typical communication is mainly based on communication between an MS and a BS, Machine to Machine (M2M) communication is made available because of rapid development of communication technologies. Machine-to-machine (M2M) communication is communication between electronic devices as the name implies. While M2M communication means wired or wireless communication between electronic devices or communication between a human-controlled device and a machine in the broadest sense, these days M2M communication typically refers to wireless communication between electronic devices.

When the concept of M2M communication was introduced in the early 1990s, it was regarded merely as the concept of remote control or telematics and the market therefor was very limited. However, M2M communication has been rapidly developed and the M2M communication market has attracted much attention all over the world over the past few years. Especially, M2M communication has a great influence in the fields of fleet management, remote monitoring of machines and facilities, smart metering for automatically measuring the working time of construction equipment and the consumption of heat or electricity, etc. in the Point Of Sales (POS) market and security-related applications. It is expected that M2M communication will find various uses in conjunction with legacy mobile communication, very high-speed wireless Internet or Wireless Fidelity (Wi-Fi), and low-output communication solutions such as ZigBee and thus will extend to Business to Customer (B2C) markets beyond Business to Business (B2B) markets.

In the era of M2M communication, every machine equipped with a Subscriber Identity Module (SIM) card can be managed and controlled remotely because it is possible to transmit data to and receive data from the machine. For example, M2M communication is applicable to a very broad range including numerous terminals and equipment such as a car, a truck, a train, a container, an automatic vending machine, a gas tank, etc.

The M2M device can report necessary information to the BS in a long-term manner or can also report necessary information to the BS using event triggering. That is, while the M2M device mostly remains in an idle state, the M2M device is awoken into an active state at intervals of a long-term period or when an event has occurred. In addition, from among all M2M devices, whereas some M2M devices may be mounted to a moving object so that each M2M device has mobility, most M2M devices may have low mobility or no mobility. Thus, there is a need for the BS to identify each idle-state MS having no mobility.

In addition, a method for allowing each idle-state MS having no mobility to transmit downlink data is also needed. However, a method for allowing each idle-state MS having no mobility to transmit downlink data has not yet been disclosed.

### DETAILED DESCRIPTION OF THE INVENTION

### Technical Problem

Accordingly, the present invention is directed to a method for allowing a base station (BS) to transmit downlink data to an idle-state MS having no mobility in a wireless communication system.

An object of the present invention is to provide a method for allowing an idle-state MS having no mobility to receive downlink data in a wireless communication system.

An object of the present invention is to provide a base station (BS) for transmitting downlink data to an idle-state MS having no mobility.

An object of the present invention is to provide a mobile station (MS) for receiving downlink data for an idle-state MS having no mobility.

It is to be understood that technical objects to be achieved by the present invention are not limited to the aforementioned technical objects and other technical objects which are not mentioned herein will be apparent from the following description to one of ordinary skill in the art to which the present invention pertains.

### Technical Solution

The object of the present invention can be achieved by providing a method for transmitting downlink data to an idle-state mobile station (MS) having no mobility by a base station (BS) in a wireless communication system, the method including: transmitting first information including information indicating the presence or absence of a downlink region allocated only for the idle-state MS having no mobility. The method may further include: transmitting second information including information regarding the allocated downlink region, wherein the first information is any one of a superframe header (SFH), a broadcast control channel (BCCH), a non-user specific A-MAP IE, an extended non-user specific A-MAP IE, and a physical downlink control channel (PDCCH). The allocated downlink region information may be indicated by a superframe index, a frame index, a subframe index, or a slot index.

The first information may further include information regarding the allocated downlink region. A radio network temporary identifier (RNTI) distinguished from an RNTI for the remaining MSs other than the idle-state MS having no mobility may be applied to the allocated downlink region. The first information may be a user specific A-MAP IE or a physical downlink control channel (PDCCH). The specific information indicating the presence or absence of the allocated downlink region may correspond to a single field contained in the first information, and a CRC of the first information may be masked with a unique identifier allocated to the idle-state MS having no mobility.

A method for receiving downlink data by an idle-state mobile station (MS) having no mobility in a wireless communication system includes: receiving first information including information indicating the presence or absence of a downlink region allocated only for the idle-state MS having no mobility. The method may further include: receiving second information including information regarding the allocated downlink region, wherein the first information is any one of a superframe header (SFH), a broadcast control channel (BCCH), a non-user specific A-MAP IE, an extended non-user specific A-MAP IE, and a physical downlink control channel (PDCCH). The allocated downlink region information may be indicated by a superframe index, a frame index, a subframe index, or a slot index.

The first information may further include information regarding the allocated downlink region, and the method further comprising receiving downlink data for the idle-state MS having no mobility based on the first information. The method may further include: receiving downlink data for the idle-state MS having no mobility on the basis of the second information. A radio network temporary identifier (RNTI) distinguished from an RNTI for the remaining MSs other than the idle-state MS having no mobility may be applied to the allocated downlink region. The first information may be a user specific A-MAP IE or a physical downlink control channel (PDCCH). The specific information indicating the presence or absence of the allocated downlink region may correspond to a single field contained in the first information, and a CRC of the first information may be masked with a unique ID allocated to the idle-state MS having no mobility. The second information may be a downlink (DL) assignment A-MAP IE or a PDCCH.

A base station (BS) for transmitting downlink data to an idle-state mobile station (MS) having no mobility in a wireless communication system includes: a transmitter configured to transmitting first information including information indicating the presence or absence of a downlink region allocated only for the idle-state MS having no mobility.

A mobile station (MS) for receiving downlink data for an idle-state mobile station (MS) having no mobility in a wireless communication system includes: a receiver configured to receive first information including information indicating the presence or absence of a downlink region allocated only for the idle-state MS having no mobility. The receiver is further configured to receive second information including information regarding the allocated downlink region. The first information may be any one of a superframe header (SFH), a broadcast control channel (BCCH), a non-user specific A-MAP IE, an extended non-user specific A-MAP IE, and a physical downlink control channel (PDCCH). The first information may further include information regarding the allocated downlink region, and wherein the receiver is further configured to receive downlink data for the idle-state MS having no mobility on the basis of the first information.

### Effects of the Invention

As is apparent from the above description, according to various embodiments, idle-state MSs having no mobility can efficiently receive downlink data for use in each idle-state MS, and the remaining MSs other than the idle-state MSs can efficiently receive downlink data to be used for themselves, resulting in improvement of communication performance.

It will be appreciated by persons skilled in the art that the effects that can be achieved with the present invention are not limited to what has been particularly described hereinabove and other advantages of the present invention will be more clearly understood from the following detailed description taken in conjunction with the accompanying drawings.

### BRIEF DESCRIPTION OF THE DRAWINGS

The accompanying drawings, which are included to provide a further understanding of the invention, illustrate embodiments of the invention and together with the description serve to explain the principle of the invention.

FIG. 1 is a block diagram illustrating a base station (BS) and a mobile station (MS) for use in a wireless communication system.

FIG. 2 is a flowchart illustrating a method for transmitting downlink data to a BS and an idle-state MS in an IEEE 802.16 system.

FIG. 3 is a conceptual diagram illustrating a method for allowing a BS to transmit downlink data to an idle-state MS having no mobility in an IEEE 802.16m system according to one embodiment of the present invention.

FIG. 4 is a conceptual diagram illustrating a method for allowing a BS to transmit downlink data to an idle-state MS having no mobility in an IEEE 802.16m system according to another embodiment of the present invention.

FIG. 5 is a conceptual diagram illustrating a method for allowing a BS to transmit downlink data to an idle-state MS having no mobility in an IEEE 802.16m system according to still another embodiment of the present invention.

FIG. 6 is a flowchart illustrating operations of an idle-state MS having no mobility according to one embodiment shown in FIG. 4.

FIG. 7 is a flowchart illustrating operations of the remaining MSs other than the idle-state MS having no mobility according to another embodiment of the present invention.

FIGS. 8A and 8B are flowcharts illustrating operations of an idle-state MS having no mobility according to one embodiment shown in FIG. 4.

FIG. 9 is a flowchart illustrating operations of the remaining MSs other than the idle-state MS having no mobility according to still another embodiment of the present invention.

### BEST MODE FOR CARRYING OUT THE INVENTION

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide a thorough understanding of the present invention. However, it will be apparent to those skilled in the art that the present invention may be practiced without such specific details. For example, the following description will be given centering upon an IEEE 802.16 system and 3GPP mobile communication system, but the present invention is not limited thereto and the remaining parts of the present invention other than unique characteristics of the IEEE 802.16 system and 3GPP system are applicable to other mobile communication systems.

In some cases, in order to prevent ambiguity of the concepts of the present invention, conventional devices or apparatuses well known to those skilled in the art will be omitted and be denoted in the form of a block diagram on the basis of important functions of the present invention. Wherever possible, the same reference numbers will be used throughout the drawings to refer to the same or like parts.

In the following description, a terminal may refer to a mobile or fixed user equipment (UE), for example, a user equipment (UE), a mobile station (MS), an Advanced Mobile Station (AMS) and the like. Also, the eNode B (eNB) may refer to an arbitrary node of a network end which communicates with the above terminal, and may include a base station (BS), a Node B (Node-B), an eNode B, an access point (AP) and the like.

In a mobile communication system, the UE may receive information from the eNode B via downlink, and may transmit information via uplink. The information that is transmitted and received to and from the UE includes data and a variety of control information. There are a variety of physical channels according to categories of transmission (Tx) and reception (Rx) information of the UE.

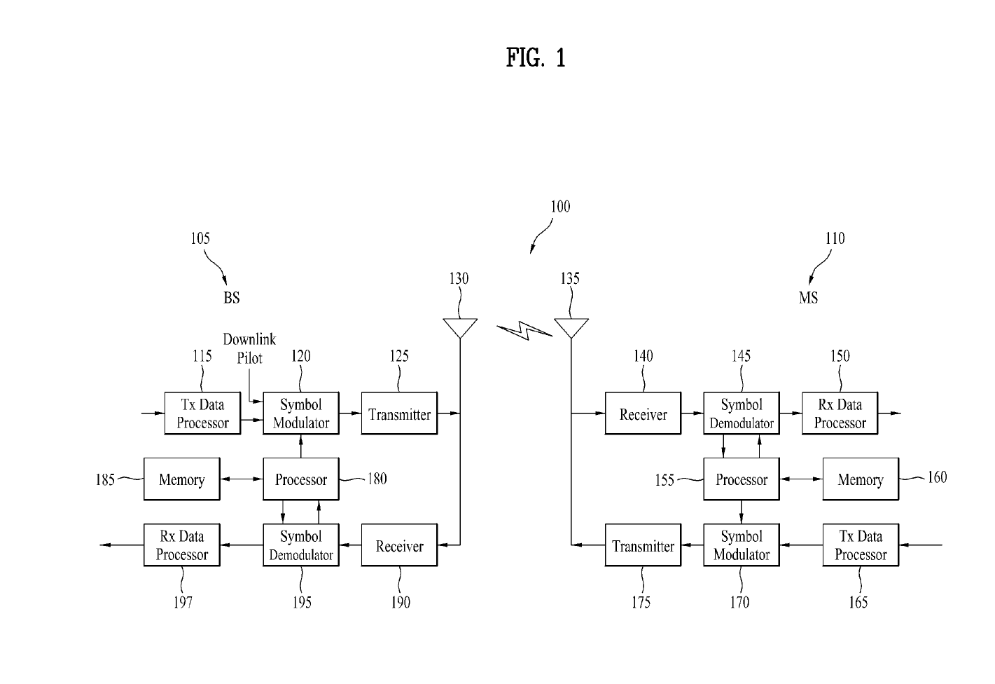

FIG. 1 is a block diagram illustrating a base station (BS) 105 and a mobile station (MS) 110 for use in a wireless communication system 100.

Referring to FIG. 1, while one BS 105 and one MS 110 are shown to simplify the configuration of the wireless communication system 100, the wireless communication system 100 may include one or more BSs and/or one or more MSs in real implementation.

Referring to FIG. 1, the BS 105 may include a Transmission (Tx) data processor 115, a symbol modulator 120, a transmitter 125, a Transmission/Reception (Tx/Rx) antenna 130, a processor 180, a memory 185, a receiver 190, a symbol demodulator 195, and an Rx data processor 197. The MS 110 may include a Tx data processor 165, a symbol modulator 170, a transmitter 175, a Tx/Rx antenna 135, a processor 155, a memory 160, a receiver 140, a symbol demodulator 145, and an Rx data processor 150. While each of the BS 105 and the MS 110 is shown as having one Tx/Rx antenna 130 or 135, it has a plurality of Tx/Rx antennas. Accordingly, the BS 105 and the MS 110 support Multiple Input Multiple Output (MIMO) according to the present invention. The BS 105 may also support both Single User MIMO (SU-MIMO) and Multi-User MIMO (MU-MIMO) according to the present invention.

The Tx data processor 115 receives traffic data, formats the received traffic data, and subjects the formatted traffic data to encoding, interleaving, and modulation, thus producing modulation symbols (“data symbols”) on downlink. The symbol modulator 120 receives the data symbols and pilot symbols, processes the received data symbols and pilot symbols, and thus provides a stream of symbols.

After multiplexing the data symbols with the pilot symbols, the symbol modulator 120 transmits the multiplexed symbols to the transmitter 125. Each transmission symbol may be a data symbol, a pilot symbol, or a null signal. The pilot symbols may be transmitted contiguously during each symbol period. The pilot symbols may be multiplexed in Frequency Division Multiplexing (FDM), Orthogonal Frequency Division Multiplexing (OFDM), Time Division Multiplexing (TDM), or Code Division Multiplexing (CDM).

The transmitter 125 receives the symbol stream, converts the received symbol stream to one or more analog signals, and additionally adjusts the analog signals (e.g. amplification, filtering, and frequency upconversion), thus generating a downlink signal suitable for transmission on a radio channel. Then the Tx antenna 130 transmits the downlink signal to the MS.

In the configuration of the MS 110, the Rx antenna 135 provides the downlink signal received from the BS to the receiver 140. The receiver 140 adjusts the received signal (e.g. by filtering, amplification, and frequency downconversion) and acquires samples by digitizing the adjusted signal. The symbol demodulator 145 demodulates the received pilot symbols and provides the demodulated pilot symbols to the processor 155, for use in channel estimation.

In addition, the symbol demodulator 145 receives a frequency response estimate for the downlink from the processor 155, acquires data symbol estimates (i.e. estimates of the transmitted data symbols) by demodulating the received data symbols, and provides the data symbol estimates to the Rx data processor 150. The Rx data processor 150 recovers the transmitted traffic data by subjecting the data symbol estimates to demodulation (i.e. symbol demapping), deinterleaving, and decoding.

The operations of the symbol demodulator 145 and the Rx data processor 150 are complementary to those of the symbol modulator 120 and the Tx data processor 115 in the BS 105.

In the MS 110, the Tx data processor 165 produces data symbols on uplink by processing traffic data. The symbol modulator 170 multiplexes the data symbols received from the Tx data processor 165, modulates the multiplexed data symbols, and provides a stream of symbols to the transmitter 175. The transmitter 175 generates an uplink signal by receiving and processing the stream of symbols and the Tx antenna 135 transmits the uplink signal to the BS 105.

In the BS 105, the uplink signal is received from the MS 110 through the Rx antenna 130. The receiver 190 acquires samples by processing the received uplink signal. The symbol demodulator 195 provides estimates of pilot symbols and data symbols received on the uplink by processing the samples. The Rx data processor 197 recovers the traffic data transmitted by the UE 110 by processing the data symbol estimates.

The processor 155 of the MS 110 and the processor 180 of the BS 105 instruct (e.g. control, adjust, and manage) operations in the MS 110 and the BS 105, respectively. The processors 155 and 180 may be connected respectively to the memories 160 and 185 that store program codes and data. The memories 160 and 185 store Operating Systems (OSs), applications, and general files in connection to the processors 155 and 180.

The processors 155 and 180 may be called controllers, microcontrollers, microprocessors, microcomputers, etc. Meanwhile, the processors 155 and 180 may be implemented in hardware, firmware, software, or a combination thereof. In a hardware configuration, the processors 155 and 180 may be provided with Application Specific Integrated Circuits (ASICs), Digital Signal Processors (DSPs), Digital Signal Processing Devices (DSDPs), Programmable Logic Devices (PLDs), Field Programmable Gate Arrays (FPGAs), etc. which are configured to implement the present invention.

In a firmware or software configuration, embodiments of the present invention may be implemented in the form of a module, a procedure, a function, etc. Firmware or software configured to implement the present invention may reside in the processors 155 and 180 or may be stored in the memories 160 and 185 and executed by the processors 155 and 180.

The layers of radio interface protocols between an MS 110 and a BS 105 may be classified into Layers 1, 2 and 3 (L1, L2 and L3) based on the three lowest layers of the Open System Interconnection (OSI) model. A physical layer corresponds to L1 and provides information transfer service on physical channels. A Radio Resource Control (RRC) layer corresponds to L3 and provides radio control resources between the MS and the network. The MS/BS may exchange RRC messages with the wireless communication network through the RRC layer.

Such a terminal that communicates in an M2M manner as described above can be referred to as an M2M device, an M2M communication terminal, or a Machine Type Communication (MTC) terminal On the other hand, a conventional MS may be referred to as a Human Type Communication (HTC) MS.

M2M devices will gradually increase in number in a given network as machine application types thereof increase. Machine application types under consideration are (1) security; (2) public safety; (3) tracking and tracing; (4) payment; (5) healthcare; (6) remote maintenance and control; (7) metering; (8) consumer devices; (9) fleet management in Point Of Sale (POS)-related and security-related application markets; (10) M2M communication at a vending machine; (11) remote control of machines and facilities and smart metering for automatically measuring the operation time of construction machines and facilities and heat or power consumption; and (12) surveillance video communication, which should not be construed as limiting the present invention. Besides, many other machine application types are being discussed. As the number of machine application types increases, the number of M2M communication devices can rapidly increase compared to the number of conventional mobile communication devices.

As described above, the M2M device may mainly transmit traffic data to the BS in a long-term manner, or may also transmit such data to the BS using event triggering. That is, while the M2M device mostly remains in an idle state, the M2M device is awoken into an active state at intervals of a long-term period or when an event has occurred. In addition, from among all M2M devices, most M2M devices may have low mobility or no mobility. As the application types of M2M devices having no mobility are continuously increased in number, the number of M2M devices managed by the same BS is also rapidly increased. Thus, it may be necessary for the BS to use an identifier (ID) for an idle-state MS having no mobility so that the BS can identify each idle-state MS having no mobility using the identifier (ID).

Prior to describing a method for transmitting/receiving downlink data for an idle-state MS (or device) having no mobility (or fixed) according to the present invention, an identifier to be used for discriminating among legacy MSs in a wireless communication system will hereinafter be described in detail. In this case, a method for transmitting a PDCCH from the BS to the MS for use in a 3GPP LTE system will hereinafter be described in detail.

The BS determines a PDCCH format according to Downlink Control Information (DCI) to be sent to the MS, and attaches a Cyclic Redundancy Check (CRC) to control information. A unique identifier (e.g., a Radio Network Temporary Identifier (RNTI)) is masked onto the CRC according to PDCCH owners or utilities. Meanwhile, a term “Station Identifier (STID)” corresponding to a RNTI of 3GPP in an IEEE 802.16m system will hereinafter be used for convenience of description.

In case of a PDCCH for a specific MS, a unique ID of an MS, for example, C-RNTI (Cell-RNTI) may be masked onto CRC. Alternatively, in case of a PDCCH for a paging message, a paging indication ID (for example, R-RNTI (Paging-RNTI)) may be masked onto CRC. In case of a PDCCH for system information (SI), a system information ID (i.e., SI-RNTI) may be masked onto CRC. In order to indicate a random access response acting as a response to an MS's random access preamble transmission, RA-RNTI (Random Access—RNTI) may be masked onto CRC. The following Table 1 shows examples of IDs masked onto PDCCH.

TABLE 4

| Type | Identifier | Description |
|---|---|---|
| UE-specific | C-RNTI | used for the UE corresponding to the |
| | | C-RNTI. |
| Common | P-RNTI | used for paging message. |
| | SI-RNTI | used for system information (It could be |
| | | differentiated according to the type of |
| | | system information). |
| | RA-RNTI | used for random access response (It could be |
| | | differentiated according to subframe or |
| | | PRACH slot index for UE PRACH |
| | | transmission). |
| | TPC-RNTI | used for uplink transmit power control |
| | | command (It could be differentiated |
| | | according to the index of UE TPC |
| | | group). |

If C-RNTI is used, PDCCH may carry control information for a specific MS. If another RNTI is used, PDCCH may carry common control information that is received by all or some MSs contained in the cell. The BS performs channel coding of the CRC-added DCI so as to generate coded data. The BS performs rate matching according to the number of CCEs allocated to a PDCCH format. Thereafter, the BS modulates the coded data so as to generate modulated symbols. In addition, the BS maps the modulated symbols to physical resource elements. As described above, the BS uses an RNTI as an MS ID in case of an LTE system, and uses an STID as an MS ID in case of an IEEE 802.16 system.

Prior to describing a method for transmitting/receiving downlink data to/from an idle-state MS having no mobility according to the present invention, an idle state or an idle mode will hereinafter be described in detail. The idle state or idle mode generally allows the MS to periodically transmit downlink broadcast traffic data without being registered with a specific BS when the MS moves in a radio link environment in which multiple BSs are present. The MS may transit (or switch) to the idle mode in order to achieve power saving when the MS has not received traffic data from a BS for a predetermined time. The MS, which has transited to the idle mode, may receive a broadcast message (for example, a paging message) broadcast by the BS during an Available Interval (AI) and determine whether the MS will transit to the normal mode or remains in the idle state. In addition, the idle-state MS performs location update so that it can inform the paging controller of the location of the idle-state MS.

In the idle state, it is possible to give a benefit to the MS by removing handover-related activation requirements and general operation requirements. In the idle state, it is possible to give a benefit to the network or the BS by providing a simple and appropriate method enabling the network or the BS to notify the MS of pending downlink traffic data and removing a radio interface and network handover (HO) traffic data from an inactive MS.

The term “paging” refers to a function to determine the location of an MS (for example, a BS or a switching center) when a terminated call for the MS is generated during mobile communication. A number of BSs that support the idle state or the idle mode may belong to a specific paging group and constitute a paging area. Here, the paging group is a logical group. The purpose of the paging group is to provide an adjacent region that enables paging in downlink when traffic destined for the MS is present. It is preferable that the paging group be configured so as to satisfy a condition that the paging group is large enough that the MS is mostly present within the same paging group and a condition that the paging group is small enough to keep paging load at an appropriate level.

The paging group may include one or more BSs and one BS may be included in one or more paging groups. The paging group is defined in a management system. A paging group-action backbone network message may be used in the paging group. The paging controller may manage initial paging of all base stations belonging to the paging group and manage a list of MSs, which are in an idle state, using a paging-announce message which is a backbone message.

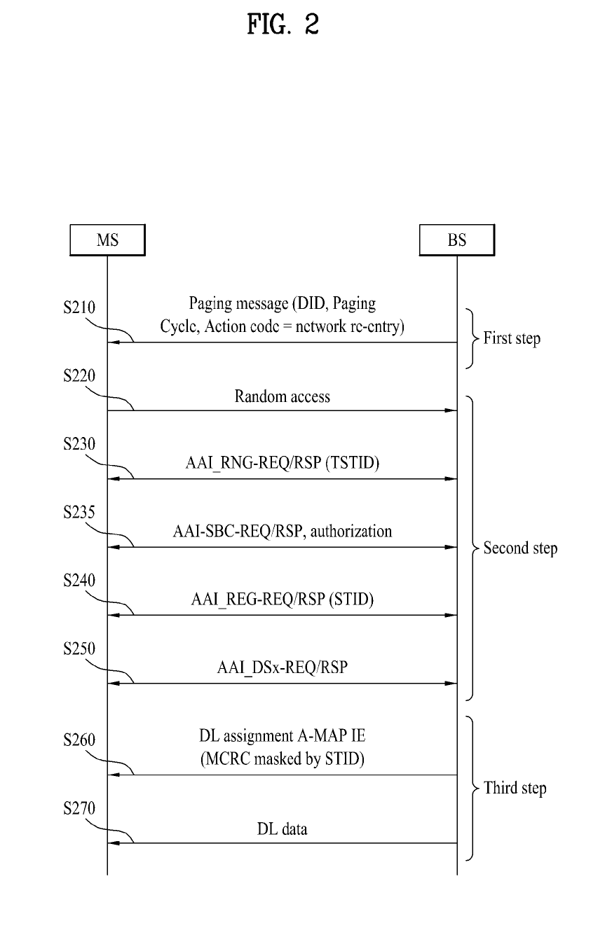

FIG. 2 is a flowchart illustrating a method for transmitting downlink data to a BS and an idle-state MS in an IEEE 802.16 system.

Referring to FIG. 2, since the BS does not recognize a correct location of each idle-state MS for transmitting/receiving data, all BSs contained in the same paging group need to transmit a paging message requesting a network re-entry to the corresponding MSs. Therefore, in order to implement data communication between the BS and the idle-state MS, each BS contained in the same paging group including MS(s) transmits a paging message requesting a network entry to the corresponding MS(s) during the listening interval of the corresponding MS(s) in step S210. The paging message includes at least one of a deregistration ID (DID), a paging cycle, and an action code (=network re-entry).

If idle-state MS information (for example, a DID and a paging cycle) is contained in the paging message, the idle-state MS needs to transit to an active state in step S220. In other words, the idle-state MS may perform random access for network entry in step S220. For example, the idle-state MS for use in the IEEE 802.16 system can perform the network re-entry procedures such as ranging, basic capability negotiation, registration, etc. Meanwhile, the idle-state MS for use in the LTE system can perform an RRC connection (re)establishment procedure. Here, whereas the BS for use in the IEEE 802.16 system allocates a TSTID, an STID, and an MTC group ID to the idle-state MS attempting to perform network re-entry, the BS for use in the 3GPP LTE or LTE-A system can allocate an RNTI and an MTC group ID to the idle-state MS attempting to perform network re-entry.

Thereafter, the idle-state MS transmits a ranging request message (for example, AAI-RNG-REQ) to the BS, and transmits a ranging response message (for example, AAI-RNG-RSP) including a temporary STID (TSTID) to the idle-state MS in step S230.

Subsequently, the idle-state MS transmits a registration request message (for example, AAI-REG-REQ) to the BS, the BS allocates an STID to the idle-state and transmits a registration response message (for example, AAI-REQ-RSP) including the STID to the idle-state MS in response to the AAI-REG-REQ message in step S240.

Thereafter, the idle-state MS may exchange dynamic-service associated messages with the BS in step S250. The BS may transmit a downlink (DL) assignment A-MAP IE to the idle-state MS. In this case, the BS transmits DL assignment A-MAP IE including an STID-masked MCRC to the idle-state MS. Then the idle-state MS may receive DL data from the BS in step S270.

In association with FIG. 2, since the BS does not recognize the correct locations of idle-state MSs, all BSs contained in the same paging group must transmit a paging message. In this case, the BS must include parameters (for example, a DID, a paging cycle, and an action code for use in the IEEE 802.16m system) for each paged MS in the paging message, so that downlink overhead may unavoidably occur.

In addition, the idle-state MS having received a paging message from the BS performs random access. In this case, when the idle-state MSs attempt to perform random access, uplink interference occurs and the possibility of generating collision between MSs attempting to perform random access may unavoidably increase.

In addition, the BS must assign an ID for identifying an active MS to the corresponding MS, so that it requires a large number of unique IDs.

However, since the idle-state MS having no mobility does not move to another BS, the BS need not recognize the correct position of the idle-state MS, so that the BS need not transmit a paging message to the idle-state MS. The BS has already recognized the correct position of the idle-state MS, such that the BS can transmit downlink data to be transmitted during the listening interval of the corresponding idle-state MS.

Therefore, it is preferable that the BS may not transmit a paging message for transmission of downlink data to the idle-state MS having no mobility, and it is also preferable that the idle-state MS having no mobility may immediately receive downlink data without performing not only reception of a separate paging message but also a network entry procedure. For this purpose, the BS needs to transmit downlink data to the idle-state MS having no mobility using a unicast scheme. In order to minimize influence upon a Human Type Communication (HTC), the BS may use IDs (for example, CID for IEEE 802.16e system, STID for IEEE 802.16m system, and RNTI for 3GPP LTE system) different from those of the legacy HTC MS as IDs for the idle-state MSs having no mobility. In case of using a new ID, all MSs should recognize specific information indicating an owner of downlink assignment information transmitted from the BS. That is, if a normal MS having the same ID and an idle-state MS having no mobility are present, the MSs must recognize whether assignment information masked with the same value belongs to the MSs themselves. If downlink resources are assigned to the MSs, the processor 155 of the corresponding MS receives messages/data transferred through the corresponding resources, and decodes the received messages/data.

If the BS desires to transmit DL data to each idle-state MS having no mobility, the BS needs to inform MTC MSs and normal MSs of specific information indicating that a specific downlink resource region is used only for the idle-state MS having no mobility.

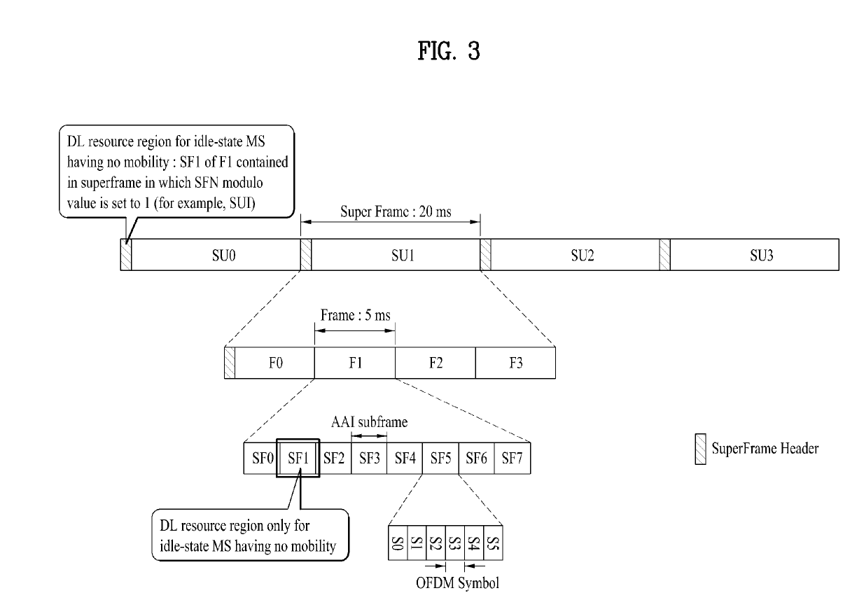

FIG. 3 is a conceptual diagram illustrating a method for allowing a BS to transmit downlink data to an idle-state MS having no mobility in an IEEE 802.16m system according to one embodiment of the present invention.

Referring to FIG. 3, the BS can inform all MSs of specific information indicating the presence or absence of a downlink region allocated only for the idle-state MSs over a channel for transmitting system information (for example, a downlink channel descriptor (DCD) for IEEE 802.16e, a superframe header (SFH) for IEEE 802.16m, and a broadcast control channel (BCCH) for 3GPP). Alternatively, the BS may inform each idle-state MS having no mobility of information regarding a downlink region allocated for some idle-state MSs having no mobility over a channel for transmission of system information.

A downlink region allocated for the idle-state MSs having no mobility may be indicated by, for example, a superframe index value, a frame index value, a subframe index value, a slot index value, etc. In accordance with an indicated resource unit, a downlink region allocated for the idle-state MS having no mobility may be one superframe, one frame, one subframe, or one slot. Meanwhile, the downlink region allocated to the idle-state MSs having no mobility may be predefined as, for example, a specific frame contained in a specific superframe. In this case, the BS need not separately perform signaling of information regarding the downlink region allocated to the idle-state MSs having no mobility.

Referring to FIG. 3, the BS can transmit information regarding a downlink region allocated for the idle-state MSs having no mobility through a superframe header (SFH) contained in a superframe SU0 indexed with ‘0’. For example, the downlink region allocated for idle-state MSs having no mobility may be a subframe SF1 having an index ‘1’ of a frame F1 corresponding to an index ‘1’ contained in a superframe SU1 having an index of 1. The processor 155 of the idle-state MS having no mobility decodes an SFH contained in the superframe SU0 having an index of 0, so that it can obtain information regarding the downlink region allocated for each idle-state MS having no mobility. Thereafter, the idle-state MSs having no mobility can recognize the presence or absence of downlink data transmitted to the idle-state MSs themselves over a control channel (for example, a user-specific A-MAP IE for the IEEE 802.16m system or a PDCCH for the 3GPP system) that transmits a control channel transmitting substantial downlink assignment region information for each MS contained in an indicated downlink region (for example, a subframe SF1 having an index ‘1’ of a frame F1 corresponding to a frame index ‘1’ of a superframe SU1 having an index ‘1’). If transmission data exists, the idle-state MS having no mobility can receive downlink data on the basis of downlink assignment region information corresponding to the corresponding control channel information.

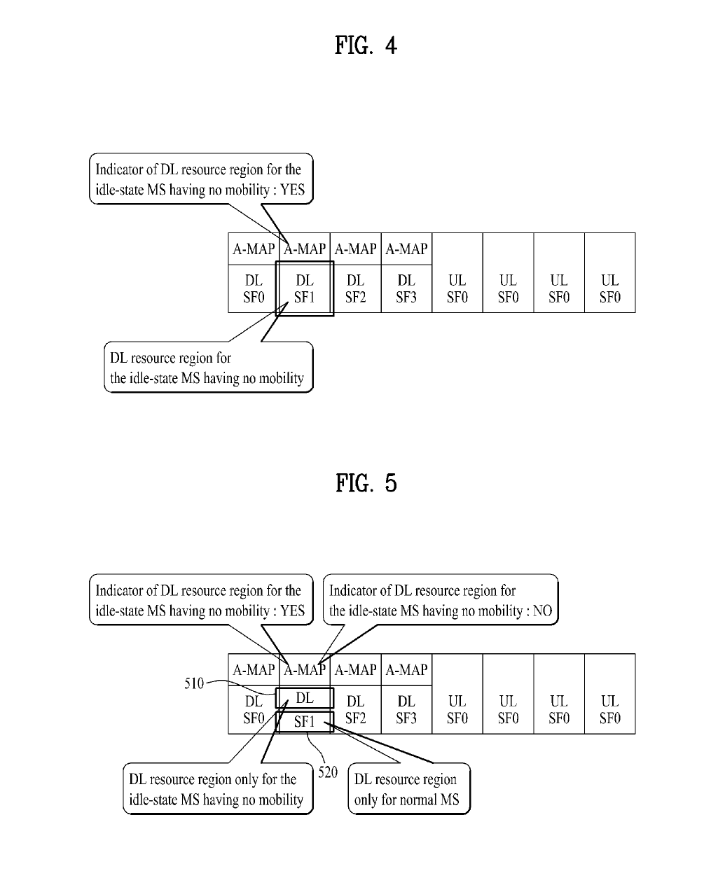

FIG. 4 is a conceptual diagram illustrating a method for allowing a BS to transmit downlink data to an idle-state MS having no mobility in an IEEE 802.16m system according to another embodiment of the present invention.

Referring to FIG. 4, the BS can inform all MSs of specific information indicating the presence or absence of a downlink region allocated only for the idle-state MSs having no mobility over a specific channel used for transmitting common assignment information. For example, the specific channel may be any one of a DL-MAP for IEEE 802.16e, a non-user specific A-MAP or an extended non-user specific A-MAP for IEEE 802.16m, or a PDCCH for 3GPP.

In addition, the BS can inform MSs (e.g., idle-state MSs having no mobility) of information regarding a downlink region allocated for the idle-state MSs having no mobility over a channel for transmitting common assignment information. That is, assuming that a channel used for transmitting common assignment information indicates a downlink region allocated only for idle-state MSs having no mobility, the downlink region allocated for each idle-state MS having no mobility may be a downlink region (e.g., a subframe for transmission of a non-user specific A-MAP, and a slot for PDCCH transmission) corresponding to an (extended) non-user specific A-MAP and a PDCCH. In addition, the BS can inform each idle-state MS of information regarding a downlink region substantially allocated to each idle-state MS having no mobility through either a separate user-specific A-MAP IE or a separate PDCCH. The BS can inform the idle-state MSs having no mobility of information regarding a downlink region substantially allocated to the idle-state MSs through a separate user-specific A-MAP IE or a separate PDCCH.

A downlink region allocated for each idle-state MS having no mobility may be a frame unit for IEEE 802.16e, a subframe unit for IEEE 802.16m, or a slot unit for 3GPP.

If the BS of the 3GPP system transmits specific information indicating downlink assignment presence/absence information for each idle-state MS through a PDCCH, any one of current RNTI reserved values (FFF4˜FFFD) may be used as an RNTI for transmission of the corresponding downlink assignment presence/absence information. Preferably, the corresponding downlink assignment presence/absence information may be located at the foremost part of a PDCCH. However, provided that BCCH or PCH control information is present, the corresponding downlink assignment presence/absence information may be located behind the BCCH or PCH control information.

FIG. 5 is a conceptual diagram illustrating a method for allowing a BS to transmit downlink data to an idle-state MS having no mobility in an IEEE 802.16m system according to still another embodiment of the present invention.

Referring to FIG. 5, the BS may attach a specific field to a channel (for example, DL-MAP for IEEE 802.16e, user specific A-MAP for IEEE 802.16m, and PDCCH for 3GPP) for transmission of assignment information of an actual MS. Here, the specific field indicates whether a downlink region for the idle-state MS having no mobility is allocated. In other words, by means of the BS, a CRC of a channel for transmission of the corresponding assignment information is masked with an ID (e.g., DID and paging cycle, or Temporary No Mobility Subscriber Identifier (TNMSID) serving as a newly defined ID) allocated to the idle-state MS having no mobility. In this case, the paging cycle is not masked with a CRC, and may be added as a single field contained in a channel for transmission of the corresponding assignment information.

In contrast, provided that the corresponding assignment information is allocated to a normal MS other than the idle-state MS having no mobility, a CRC of a channel for transmission of the corresponding assignment information is masked with an ID (e.g., STID, RNTI, etc.) allocated to the corresponding MS by the BS, and the corresponding field of a channel for transmission of assignment information is established as a specific value indicating normal MS assignment usage, so that the resultant field including the specific value is then transmitted.

The BS includes information regarding a downlink region allocated to the idle-state MS having no mobility in a channel (for example, DL-MAP for IEEE 802.16e, user specific A-MAP for IEEE 802.16m, and PDCCH for 3GPP) for transmitting assignment information of an actual MS, and transmits the resultant channel to the idle-state MS having no mobility. For example, the BS may inform each MS of specific information regarding a downlink region 510 used only for the idle-state MSs having no mobility through a user specific A-MAP of a specific subframe. On the other hand, the BS can allocate a downlink region 520 to the remaining MSs other than the idle-state MS having no mobility through a user specific A-MAP of the specific subframe. For example, each of the downlink region 510 for the idle-state MSs having no mobility and the downlink region 520 for the remaining MSs other than the idle-state MSs having no mobility may be allocated as an FDM (Frequency Division multiplexing) format as shown in FIG. 5.

A method for allowing the BS for use in the IEEE 802.16m system to transmit downlink data to an idle-state MS having no mobility according to another embodiment will hereinafter be described in detail. Table 2 shows a CRC mask for use in the IEEE 802.16m system.

TABLE 2

| Masking | | |
|---|---|---|
| Prefix | | |
| (1 bit MSB) | Remaining 15 bit LSBs | |
| | Type Indicator | Masking Code |
| 0b0 | 0b000 | 12 bit STID or TSTID |
| | 0b001 | Refer to Table 844 |
| | 0b010 | Refer to Table 845 |

| | |
|---|---|
| 0b1 | 15 bit RA-ID: The RA-ID is derived from the AMS random |
| | access attributes (i.e., superframe number (LSB 5 bits), |
| | frame_index (2 bits), preamble code index for ranging |
| | or BR (6 bits) and opportunity index for ranging or BR (2 |
| | bits)) as defined below: |
| | RA-ID = (LSB 5 bits of superframe number\|frame_index\| |
| | preamble_code_index\|opportunity_index) |

Referring to Table 2, a masking prefix is 1 bit of ‘0’ or ‘1’. If the masking prefix is set to ‘0’, this implies a masking code according to a type indicator. Only type indicators of ‘000’, ‘001’, and ‘010’ are defined. If the type indicator is ‘000’, this indicates a 12-bit STID or TSTID. If the type indicator is ‘001’, Table 844 is referred to. If the type indicator is ‘010’, Table 845 is referred to. Table 844 and Table 845 correspond to Table 3 and Table 4, respectively.

TABLE 3

| Decimal | |
|---|---|
| Value | Description |
| 0 | Used to mask Broadcast Assignment A-MAP IE for broadcast |
| | or ranging channel assignment |
| 1 | Used to mask BR-ACK A-MAP IE |
| 2-128 | Used to mask Group Resource Allocation A-MAP IE (group ID) |
| Others | Reserved |

TABLE 4

| Decimal | |
|---|---|
| Value | Description |
| 4095 | Used to mask Broadcast Assignment A-MAP IE |
| | for multicast assignment |
| Others | Reserved |

Table 3 shows a masking code for the type indicator ‘001’, and Table 4 shows a masking code for the type indicator ‘010’.

In this embodiment, the BS can inform each MS of specific information indicating whether a specific downlink region is allocated to either an idle-state MS having no mobility or the remaining MSs other than the idle-state MS, using a masking prefix contained in a CRC and a 3-bit type indicator. For example, the 3-bit type indicator may be defined as ‘011’ not defined yet. Thus, the BS masks an ID of the idle-state MS having no mobility with both a masking prefix ‘0’ and a 3-bit type indicator ‘011’, so that the BS can indicate that a specific downlink region is a downlink region allocated to the idle-state MS having no mobility.

However, if a total number of bits of the ID fields is higher than a total number of bits of the CRC, bits (for example, x bits and paging cycle of a DID, and y bits of TNMSID acting as a newly defined ID) of the remaining unmasked ID fields may be added as one field contained in a channel (for example, user specific A-MAP, PDCCH) for transmitting actual assignment information of the MS.

A method for allowing the BS of the IEEE 802.16m system to transmit downlink data to the idle-state MS having no mobility according to another embodiment will hereinafter be described in detail.

When the BS desires to transmit downlink data to the idle-state MS having no mobility, the BS can transmit assignment information for transmitting downlink data and a message including actual data to the corresponding idle-state MS having no mobility through the assigned downlink region during the listening interval of the idle-state MS having no mobility. The BS masks a CRC of downlink resource assignment information with a parameter (for example, DID and paging cycle, or TNMSID acting as a newly defined ID) for identifying the idle-state MSs having no mobility, and transmits the masked result, so that the corresponding idle-state MSs having no mobility can recognize the masked result. That is, the corresponding idle-state MS having no mobility can recognize whether downlink data corresponding to the idle-state MS itself is transmitted from the BS on the basis of parameters (for example, DID and paging cycle, and TNMSID acting as a newly defined ID) for discriminating (or identifying) each idle-state MS having no mobility.

In this case, CRC of downlink resource assignment information may be masked with one group ID including a plurality of idle-state MSs having no mobility.

For example, the BS can inform a single group including the idle-state MSs having no mobility of specific information indicating that downlink data is transmitted to the single group using any one of reserved values of the paging cycle. The following table 5 shows a plurality of values for indicating a paging cycle for legacy MSs.

TABLE 5
Used to indicate Paging cycle for the AMS

| | |
|---|---|
| 0x00: | 4 superframes |
| 0x01: | 8 superframes |
| 0x02: | 16 superframes |
| 0x03: | 32 superframes |
| 0x04: | 64 superframes |
| 0x05: | 128 superframes |
| 0x06: | 256 superframes |
| 0x07: | 512 superframes |
| 0x08-0x15: | reserved |

Referring to Table 5, reserved values of the paging cycle are 0x08-0x15. The BS can select any one of the reserved values 0x08-0x15 as an ID of a group including the idle-state MSs having no mobility. In addition, the processor 180 of the BS may mask a CRC of downlink resource assignment information with a single selected value, or may include the CRC in the assignment information. Likewise, the BS can transmit not only downlink assignment information that is CRC-masked using any one of reserved values of the paging cycle, but also actual downlink data, so that downlink data can be transmitted within the listening interval of the idle-state MSs having no mobility.

In another example, the BS can allocate a TNMSID acting as a newly defined ID for group purposes. In other words, the BS may perform CRC masking between downlink assignment information and the TNMSID selected as an ID of a group including idle-state MSs having no mobility, and then transmit the CRC-masked result. In this case, the BS can transmit not only downlink assignment information CRC-masked with the corresponding TNMSID, but also downlink data.

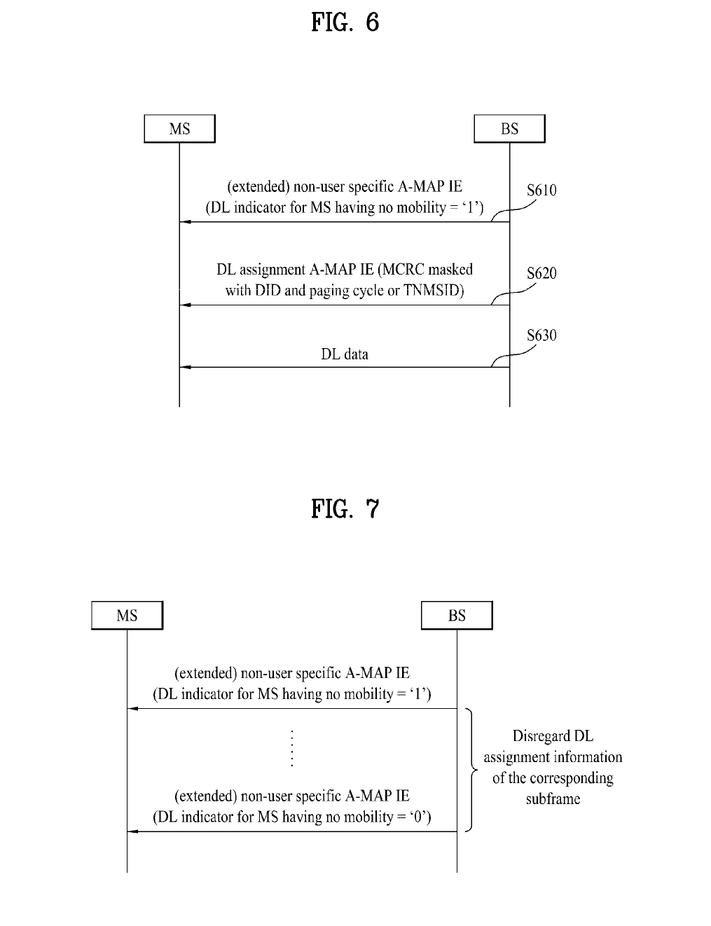

FIG. 6 is a flowchart illustrating operations of an idle-state MS having no mobility according to one embodiment shown in FIG. 4.

Referring to FIG. 6, an idle-state MS having no mobility may receive a downlink indicator through either a non-user specific A-MAP IE or an extended non-user specific A-MAP IE during the listening interval for the idle-state MS in step S610. In this case, the transmitted downlink indicator may indicate whether the user specific A-MAP IE transmitted in a subframe corresponding to the corresponding A-MAP IE is control information used only for the idle-state MS having no mobility.

If the downlink indicator value transmitted from the BS is set to ‘0’, the idle-state MS having no mobility may disregard a downlink A-MAP IE (for example, DL assignment information) contained in a subframe corresponding to the received non-user specific A-MAP IE or extended non-user specific A-MAP IE. However, although a current region is a region for the remaining MSs other than the idle-state MS having no mobility, since a broadcast/multicast message is transmitted through the corresponding region, the idle-state MS having no mobility needs to confirm broadcast/multicast messages such as a paging message and a system configuration descriptor (SCD) message.

On the other hand, if the downlink indicator value transmitted from the BS is set to ‘1’, the idle-state MS having no mobility may receive and confirm a downlink A-MAP IE (for example, DL assignment information) contained in a subframe corresponding to the received non-user specific A-MAP IE or extended non-user specific A-MAP IE in step S620. In this case, the downlink A-MAP IE may include an MCRC masked with DID and paging cycle or another MCRC masked with TNMSID. Since the idle-state MS having no mobility has a pre-allocated ID (for example, DID and paging cycle or a newly defined TNMSID) for the idle-state MS having no mobility, the idle-state MS determines whether current information is DL assignment information that is CRC-masked with the DID and paging cycle corresponding to the idle-state MS ID or the TNMSID in step S620.

Thereafter, provided that there is downlink (DL) data region information for the idle-state MS having no mobility (i.e., provided that DL assignment information being CRC-masked with the idle-state MS ID is transmitted), the idle-state MS having no mobility receives DL data in step S630, and the processor 155 of the idle-state MS having no mobility can decode a DL data burst of the corresponding region in step S630.

FIG. 7 is a flowchart illustrating operations of the remaining MSs other than the idle-state MS having no mobility according to another embodiment of the present invention.

An active-state MS and an idle-state MS having mobility may be used as the remaining MSs other than an idle-state MS having no mobility. In accordance with the embodiment, the above-mentioned MSs may be referred to as normal MSs for convenience of description. The active-state MS may receive a downlink indicator through a non-user specific A-MAP IE or (extended) non-user specific A-MAP IE within almost all downlink intervals. The idle-state MS having mobility may receive a downlink indicator through a non-user specific A-MAP IE or (extended) non-user specific A-MAP IE within its own listening interval. The downlink indicator may indicate whether the user specific A-MAP IE transmitted in a subframe corresponding to the corresponding A-MAP IE is control information only for the idle-state MS having no mobility.

If the downlink indicator value transmitted from the BS is set to ‘0’, a normal MS performs general operations according to respective states.

On the other hand, if the downlink indicator value transmitted from the BS is set to ‘1’, a normal MS disregards a downlink A-MAP IE (for example, DL assignment information) contained in a subframe corresponding to a non-user specific A-MAP IE or extended non-user specific A-MAP IE. That is, if the downlink indicator value transmitted from the BS is set to ‘1’, the normal MS may not decode downlink assignment information of a subframe corresponding to a non-user specific A-MAP IE or extended non-user specific A-MAP IE. However, although a current region is a region for the idle-state MS having no mobility, since a broadcast/multicast message is transmitted through the corresponding region, a normal MS may confirm broadcast/multicast messages such as a paging message and a system configuration descriptor (SCD) message.

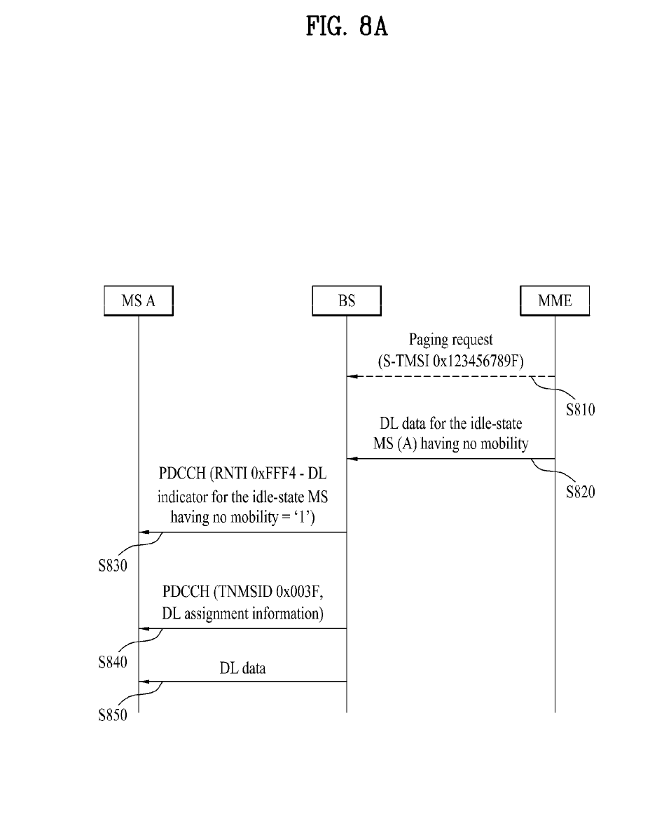

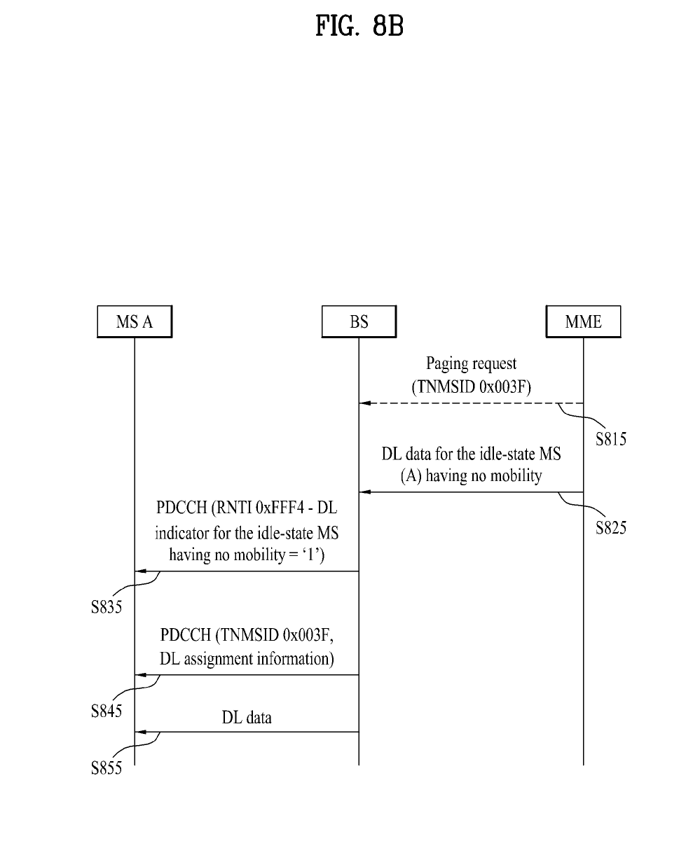

FIGS. 8A and 8B are flowcharts illustrating operations of an idle-state MS having no mobility according to one embodiment shown in FIG. 4.

Referring to FIG. 8A, MME may transmit a paging request message to a BS in step S810. In this case, the paging request message may include an S-TMSI acting as an ID for the idle-state MS having no mobility. For example, S-TMSI may be 0x123456789F. The MME may transmit downlink data for the idle-state MS (A) having no mobility to the BS in step S820.

Thereafter, the BS may mask one (0XFFF4) of reserved RNTIs for a downlink indicator (for example, a bit value ‘1’) indicating control information for the idle-state MS having no mobility with the CRC, such that the BS can transmit a PDCCH according to the CRC-masked result in step S830. The idle-state MS (A) having no mobility receives a PDCCH obtained when one (0XFFF4) of reserved RNTIs is CRC-masked, such that it can recognize that control information indicating assignment or non-assignment of downlink resources for the idle-state MS having no mobility has been transmitted, and it can also determine that a slot for the corresponding PDCCH was implicitly allocated for the idle-state MS having no mobility. In addition, upon receiving a downlink indicator of ‘1’, the idle-state MS (A) having no mobility can determine that a slot corresponding to a PDCCH has been allocated for the idle-state MS having no mobility.

In this case, assuming that all MSs do not receive a PDCCH obtained when one (0XFFF4) of reserved RNTIs is CRC-masked, it can be determined that the slot for the corresponding PDCCH has been implicitly allocated for a normal MS.

Thereafter, the idle-state MS (A) having no mobility may receive DL assignment information that is CRC-masked with a TNMSID (for example, 0x003F) from among IDs for the idle-state MSs having no mobility, from the BS in step S840. The idle-state MS (A) having no mobility may receive DL data in a DL region indicated by a PDCCH including DL assignment information in step S850.

FIG. 8A is a flowchart illustrating an exemplary case in which an MME and a BS manage an ID of the idle-state MS having no mobility in different ways. That is, the MME manages an ID of the idle-state MS having no mobility using an S-TMSI, and the BS manages the idle-state MS having no mobility using a TNMSID acting as the newly defined ID.

In another example, as can be seen from FIG. 8B, the MME can transmit a paging request message to the BS in step S815. In this case, the paging request message may include a TNMSID corresponding to an ID of the idle-state MS having no mobility. For example, the TNMSID may be denoted by ‘0x003F’. The MME may transmit DL data for the idle-state MS (A) having no mobility to the BS in step S825.

Thereafter, the BS can transmit a PDCCH by performing CRC-masking of one (0XFFF4) of reserved RNTIs for a downlink indicator (for example, a bit value ‘1’) indicating control information of the idle-state MS having no mobility in step S835. The idle-state MS (A) having no mobility receives a PDCCH obtained when one (0XFFF4) of reserved RNTIs is CRC-masked, such that it can recognize that control information indicating assignment or non-assignment of downlink resources for the idle-state MS having no mobility has been transmitted, and it can also determine that a slot for the corresponding PDCCH has been implicitly allocated for the idle-state MS having no mobility. In addition, upon receiving a downlink indicator of ‘1’, the idle-state MS (A) having no mobility can determine that the slot corresponding to the PDCCH has been allocated for the idle-state MS having no mobility.

In this case, assuming that all MSs do not receive a PDCCH obtained when one (0XFFF4) of reserved RNTIs is CRC-masked, it can be determined that the slot for the corresponding PDCCH has been allocated for a normal MS.

Thereafter, the idle-state MS (A) having no mobility may receive DL assignment information that is CRC-masked with a TNMSID (for example, 0x003F) from among IDs for the idle-state MSs having no mobility, from the BS in step S845. The idle-state MS (A) having no mobility may receive DL data in a DL region indicated by a PDCCH including DL assignment information in step S855. FIG. 8B is a flowchart illustrating an exemplary case in which an MME and a BS equally manage an ID of the idle-state MS having no mobility.

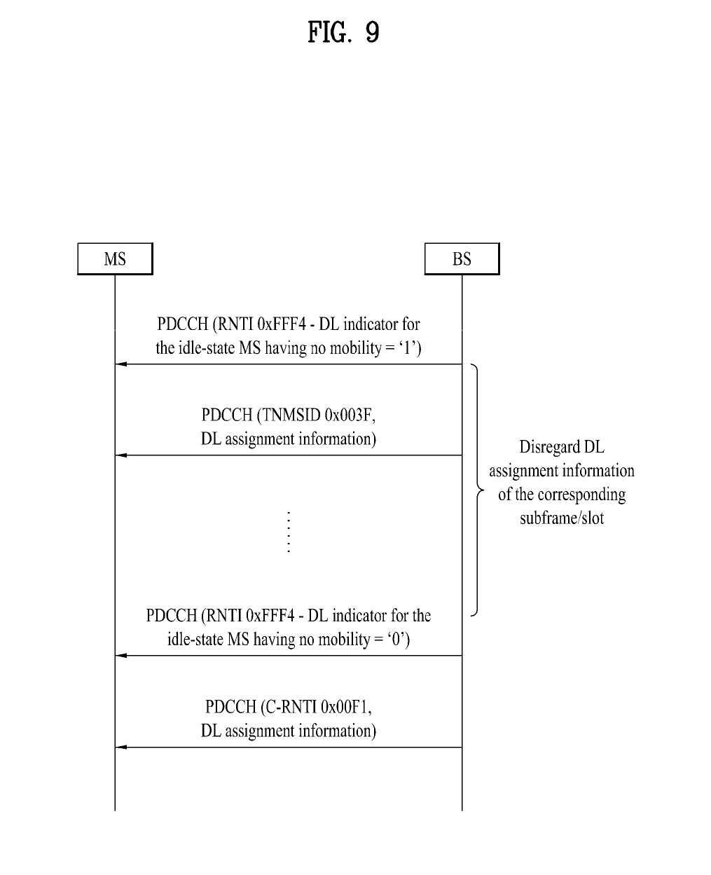

FIG. 9 is a flowchart illustrating operations of the remaining MSs other than the idle-state MS having no mobility according to still another embodiment of the present invention.

Referring to FIG. 9, an active-state MS and an idle-state MS having mobility may be used as the remaining MSs other than an idle-state MS having no mobility. The BS may mask one (0XFFF4) of reserved RNTIs for a downlink indicator (for example, a bit value ‘1’) acting as control information indicating assignment or non-assignment of downlink resources for the idle-state MS having no mobility with the CRC, such that the BS can transmit a PDCCH according to the CRC-masked result. The remaining MSs other than the idle-state MS having no mobility can receive a PDCCH including a downlink indicator acting as control information for the idle-state MS having no mobility from the BS. A normal MS receives a PDCCH obtained when one (0XFFF4) of reserved RNTIs is CRC-masked, such that it can recognize that control information indicating assignment or non-assignment of downlink resources for the idle-state MS having no mobility has been transmitted, and it can also determine that a slot for the corresponding PDCCH was implicitly allocated for the idle-state MS having no mobility. In addition, upon receiving a downlink indicator of ‘1’, a normal MS can determine that a slot corresponding to a PDCCH has been allocated for the idle-state MS having no mobility.

In this case, assuming that all MSs do not receive a PDCCH obtained when one (0XFFF4) of reserved RNTIs is CRC-masked, it can be determined that the slot for the corresponding PDCCH has been implicitly allocated for a normal MS.

As a result, the remaining MSs other than the idle-state MS having no mobility may disregard DL assignment information of the corresponding slot of the corresponding subframe indicated by a PDCCH. Thereafter, the remaining MSs other than the idle-state MS having no mobility can receive a PDCCH, that is obtained when one (0XFFF4) of reserved RNTIs for a downlink indicator (for example, a bit value ‘0’) indicating control information of the remaining MSs other than the idle-state MS having no mobility is CRC-masked, from the BS. Thereafter, the remaining MSs other than the idle-state MS having no mobility can receive a PDCCH including DL assignment information for the above remaining MSs. In this case, the PDCCH including DL assignment information is obtained by performing CRC-masking of a C-RNTI (for example, 0x00F1), and is then transmitted.

As described above, according to various embodiments, the idle-state MSs having no mobility can efficiently receive DL data for the idle-state MS having no mobility, and the remaining MSs other than the above idle-state MSs can efficiently receive DL data for themselves, such that communication performance can be greatly improved.

Exemplary embodiments described hereinbelow are combinations of elements and features of the present invention. The elements or features may be considered selective unless mentioned otherwise. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. Also, it will be obvious to those skilled in the art that claims that are not explicitly cited in the appended claims may be presented in combination as an exemplary embodiment of the present invention or included as a new claim by subsequent amendment after the application is filed.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

### INDUSTRIAL APPLICABILITY

The method and apparatus for transmitting and receiving DL data for the idle-state MS having no mobility according to the embodiments of the present invention can be applied to various mobile communication systems, for example, 3GPP LTE, LTE-A, IEEE 802, and the like.

1-20. (canceled)

21. A method for transmitting downlink data in a wireless communication system, the method comprising:
transmitting, by a base station to a Machine to Machine (M2M) device, first information including information indicating a downlink resource assignment for the M2M device is present,
wherein the M2M device corresponds to an idle mode fixed M2M device or an idle mode M2M device having no mobility,
wherein the first information further includes information regarding an allocated downlink resource region, and
wherein the first information is a user specific A-MAP IE or a physical downlink control channel (PDCCH).

22. The method of claim 21, wherein the allocated downlink resource region information further includes a location or size of the allocated downlink resource region.

23. The method of claim 21, wherein a cyclic redundancy check (CRC) of the first information is masked with a unique identifier allocated to the idle mode fixed M2M device.

24. The method of claim 23, wherein a masking prefix of the CRC is set to ‘0b0’ and a type indicator of the CRC is set to ‘0b011’.

25. The method of claim 21, further comprising:
transmitting, by the base station to the M2M device, the downlink data through the allocated downlink resource region.

26. The method of claim 21, wherein the first information further includes paging cycle information.

27. A method for receiving downlink data in a wireless communication system, the method comprising:
receiving, by a Machine to Machine (M2M) device from a base station, first information including information indicating a downlink resource assignment for the M2M device is present, wherein the M2M device corresponds to an idle mode fixed M2M device or an idle mode M2M device having no mobility,
wherein the first information further includes information regarding the allocated downlink resource region, and
wherein the first information is a user specific A-MAP IE or a physical downlink control channel (PDCCH).

28. The method of claim 27, wherein the allocated downlink resource region information further includes a location or size of the allocated downlink resource region.

29. The method of claim 27, wherein a cyclic redundancy check (CRC) of the first information is masked with a unique identifier allocated to the idle mode fixed M2M device.

30. The method of claim 29, wherein a masking prefix of the CRC is set to ‘0b0’ and a type indicator of the CRC is set to ‘0b011’.

31. The method of claim 30, further comprising:
receiving, by the M2M device from the base station, the downlink data through the allocated downlink resource region.

32. The method of claim 27, wherein the first information further includes paging cycle information.

33. A base station for transmitting downlink data in a wireless communication system, the base station comprising:
a transmitter; and
a processor,
wherein the processor is configured to control that the transmitter transmits, first information including information indicating a downlink resource assignment for a Machine to Machine (M2M) device is present, to the M2M device,
wherein the M2M device corresponds to an idle mode fixed M2M device or an idle mode M2M device having no mobility,
wherein the first information further includes information regarding an allocated downlink resource region, and
wherein the first information is a user specific A-MAP IE or a physical downlink control channel (PDCCH).

34. The base station of claim 33, wherein the processor is configured to control that the transmitter further transmits the downlink data through the allocated downlink resource region to the M2M device.

35. A Machine to Machine (M2M) device for receiving downlink data in a wireless communication system, the M2M device comprising:
a receiver; and
a processor,
wherein the processor is configured to control that the receiver receives, first information including information indicating a downlink resource assignment for the M2M device is present, from a base station,
wherein the M2M device corresponds to an idle mode fixed M2M device or an idle mode M2M device having no mobility,
wherein the first information further includes information regarding the allocated downlink resource region, and
wherein the first information is a user specific A-MAP IE or a physical downlink control channel (PDCCH).

36. The M2M device of claim 35, wherein the processor is configured to control that the receiver further receives the downlink data through the allocated downlink resource region from the base station.
